(19) United States
(12) Patent Application Publication
(10) Pub. No.: US 2008/0043237 A1
(43) Pub. Date: Feb. 21, 2008

(54) Automatic laser alignment system

(76) Inventors: Jimm Grimm, Huntington Valley, PA (US); Christopher Grimm, Summerville, SC (US); James Grimm, Richmond, IN (US)

Correspondence Address: Jimm Grimm, P.O. Box 107, Huntingdon Valley, PA, 19006, US

(21) Appl. No.: 11/888,761

(22) Filed: Aug. 2, 2007

Related U.S. Application Data
(60) Provisional application No. 60/835,772, filed on Aug. 7, 2006.
(60) Provisional application No. 60/836,239, filed on Aug. 9, 2006.

(51) Int. Cl. G01B 11/00

(52) U.S. Cl. 356/399

(57) ABSTRACT

A device that automatically aligns laser beams to corresponding targets to establish a frame of reference for radiation oncology or diagnostic imaging. The device is comprised of one or more lasers and corresponding laser alignment targets, two motors for each laser to control its direction, a laser imaging device or devices, a wireline or wireless network, a computer for controlling each laser's motors, and a central computer connected to the laser imaging device(s). Each laser alignment target has crosshairs to align the laser beam to, and each laser alignment target also has unique identifying marks to distinguish it from the other lasers' targets. Each laser has two means for automatic alignment, one to adjust the laser beam positive or negative along X coordinates, and another to adjust the laser beam positive or negative along Y coordinates. The laser imaging device(s) is used to measure how accurately the laser beam is aligned, and the images are fed to the central computer which calculates the laser alignment error for each laser, and sends feedback across the network to each laser's alignment computer. The computer for each laser uses the error feedback to control the laser's automatic alignment means so as to minimize the alignment error.

### FIELD OF THE INVENTION

The invention relates to laser alignment systems that are used as a frame of reference for positioning patients and quality assurance equipment in radiation oncology and diagnostic imaging. The invention is an automated system to conveniently and accurately align the lasers.

### BACKGROUND AND SUMMARY OF THE INVENTION

Linear accelerators, X-Ray simulators and other equipment for radiation oncology typically have a gantry that can rotate about a focal point called the isocenter. At any gantry angle the radiation beam points through the isocenter. Typically there is a laser on each wall perpendicular to the axis of rotation of the gantry, and another laser on the ceiling directly above the isocenter, and some clinics also have a laser on the wall facing the gantry. The laser beams should all pass through the isocenter, to assist in positioning the patient and other treatment devices.

Diagnostic imaging equipment such as X-Ray simulators, CT scanners, MRI scanners, PET scanners, etc. are often used in conjunction with radiation oncology linear accelerators. When used in conjunction with a linear accelerator, the diagnostic imaging equipment will also have laser beams that intersect at a model of the linear accelerator's isocenter, and the presently disclosed invention can be used to align these laser beams to the model isocenter. The diagnostic imaging equipment is used to determine the location of the tumor and patient's internal anatomy as well as the external patient contours. Treatment planning software is used to plan optimal delivery of the radiation to the tumor, based on the information from the diagnostic imaging equipment. This requires the diagnostic imaging equipment to have the same localization frame of reference as the linear accelerator. For this reason, the diagnostic imaging equipment also has lasers in a similar configuration as the linear accelerator, where all the laser beams intersect at a certain location relative to the diagnostic imaging equipment, such a point as models the isocenter of the linear accelerator. Immediately prior to the imaging study, while the patient is lying on the couch of the imaging machine, marks are placed on the patient's skin where the laser beams impinge the patient's skin, and radiopaque markers are placed on the skin marks. The radiopaque markers can be seen on the diagnostic image and are visible in the treatment planning software, so the location of the patient's internal anatomy may be calculated relative to the linear accelerator's isocenter. The marks on the patient's skin are used to align the patient to the linear accelerator's isocenter during each radiation therapy treatment.

For radiation oncology equipment with a gantry, ideally all the laser beams would pass exactly through the isocenter to provide a frame of reference. Unfortunately, aligning the lasers to the isocenter is still a tedious and inaccurate manual process. The user places a laser target assembly, such as U.S. Pat. No. 5,467,193 or as in FIG. 3, 4, or 5, or similar, on the linear accelerator's couch at the isocenter, or on the simulator's couch at the model of the isocenter. In applications with a gantry, for laser target assemblies like U.S. Pat. No. 5,467,193 or FIG. 3, the vertical height of the isocenter is typically either determined by the gantry's optical distance indicator (ODI), or by the couch height gauge, or by measuring with the mechanical isocenter pointer. The lateral and longitudinal position of the isocenter is determined by aligning the gantry's light field with alignment marks on the laser target assembly. Most laser target assemblies have a built in bubble level and leveling screws to ensure the targets are reasonably level. Once the laser target is sufficiently level and sufficiently close to the gantry's isocenter, the clinical user manually aligns the laser beams to the targets. This is a tedious manual process. For laser targets as in FIG. 4 or 5, a procedure as indicated by the Winston-Lutz reference cited above is used to align the target to the linac's isocenter. Once the laser target is aligned to the isocenter, the lasers can be aligned to the target. Each laser has two means for adjustment, such as two knobs, two adjustment screws, two motors, etc. Each laser has one means to adjust the laser beam positive or negative along X coordinates, and another means to adjust the laser beam positive or negative along Y coordinates. To simplify the language, subsequently these means for adjustment will simply be called “knobs,” although other means for adjustment, including mechanical, electrical or hydraulic, either manually or computer driven, could obviously be used as well. In normal sized treatment rooms, it is hard for the clinical user to see the target at the isocenter clearly when they are standing way over at the wall adjusting the lasers. So the user needs to adjust the laser, walk over to the laser target to see how far off it is, walk back over to the wall, readjust the laser, and so forth. It often takes several iterations and the final result could still be misaligned by more than one millimeter. The ceiling lasers are even more inconvenient to adjust. An invention that could automatically align the lasers to better accuracy would be very beneficial to the clinical users and to the patients.

For applications without a gantry, a model of the linac's isocenter is used as described above. The location of the model isocenter in 3D space may be chosen by the user, as long as the laser beams are all perpendicular to the center bore of the diagnostic imaging device and at multiples of 90 degree angles to one another. The critical issue is that the laser beams must all intersect as close to the chosen model isocenter as possible.

Accurate radiation therapy treatment requires that the laser alignment of both the diagnostic imaging equipment and the linear accelerator are extremely accurate. If some of the lasers for the linear accelerator happened to be misaligned by a couple millimeters and the corresponding lasers for the diagnostic imaging equipment happened to be misaligned by a couple millimeters in the opposite direction, the combined error could be nearly half a centimeter. The presently disclosed invention could reduce this error to tenths of millimeters, and it would be far more convenient to use than the existing manual alignment procedure.

More generally, the same invention could be used to automatically align any lasers to any arbitrary targets, as long as the lasers had a direct line of sight to the corresponding laser targets, and as long as the laser imaging device or devices could obtain adequate images of all the laser targets. The user places the targets such that when lasers are aligned to them, the desired frame of reference is established.

### BRIEF DESCRIPTION OF THE DRAWINGS

FIG. 1 is a drawing of a prior art manually adjusted laser.

FIG. 2 is a drawing of an automatically adjusting laser.

FIG. 3 is an example of a laser target assembly.

FIG. 4 is a laser target pointer (LTP), another type of laser target assembly.

FIG. 5 is a laser target cube (LTC), another type of laser target assembly.

FIG. 6 is a diagram of the preferred embodiment of the invention as it relates to linear accelerators, X-Ray simulators, or other machines with a gantry.

FIG. 7 is a diagram of the preferred embodiment of the invention as it relates to CT, MRI, PET or other diagnostic imaging devices without a gantry.

FIG. 8 is a flowchart for the program of the central computer 330.

FIG. 9 is a flowchart for the program of the laser alignment computer 310.

FIG. 10 is a block diagram of the invention for a general purpose application.

FIG. 11 is a screen shot of the user interface window on the central computer 330.

### DETAILED DESCRIPTION OF THE INVENTION

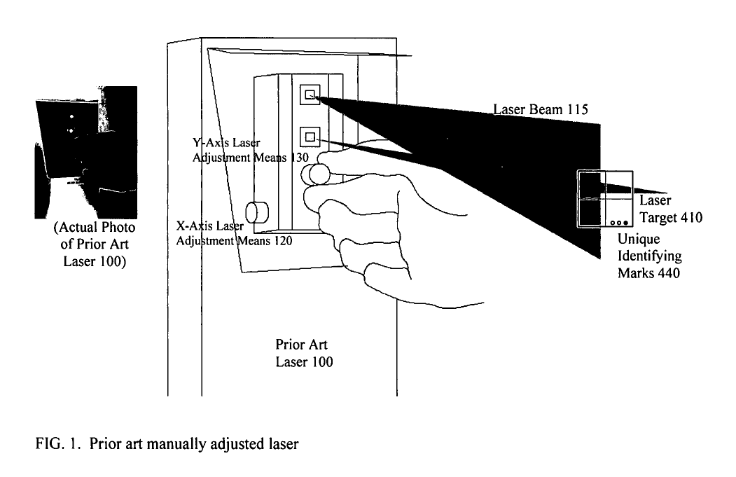

A prior art manually alignable laser 100 is shown in FIG. 1. The laser beam 115 is emitted from the laser 100, and the X-Axis manual adjustment means 120 can align the laser beam 115 positive or negative in the X direction, and the Y-Axis manual adjustment means 130 can align the laser beam 115 positive or negative in the Y direction. There are many other varieties of prior art lasers with different kinds of knobs, screws, motors, or other means to realign the laser beam 115. The present invention applies to any prior art laser that has means for the user to align the laser beam in two orthogonal dimensions. X and Y coordinates are relative to the laser target 410. This manual alignment process is tedious and subject to potentially large errors, so an automated system with better accuracy is very desirable. In the automatic system, the manual adjustment means 120 and 130 will be replaced with a connection to automatic adjustment means, such as motors, hydraulics, or any other sort of actuator that can effect the motion. To simplify the language, subsequently these means for automatic adjustment will simply be called “motors,” although other means for adjustment, could obviously be used as well.

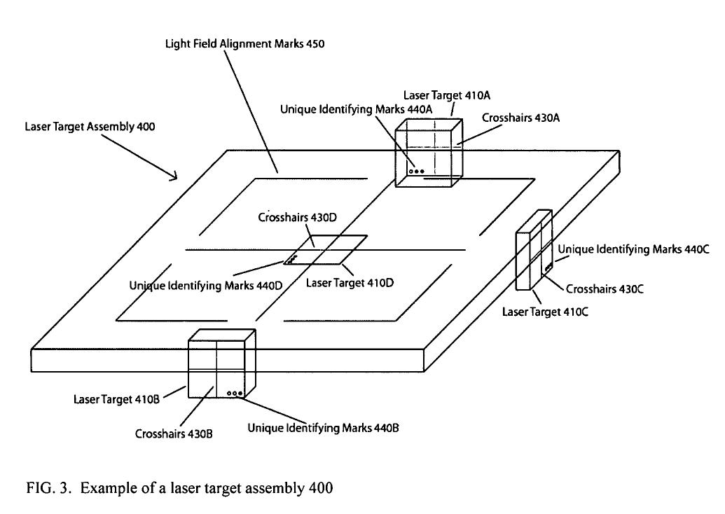

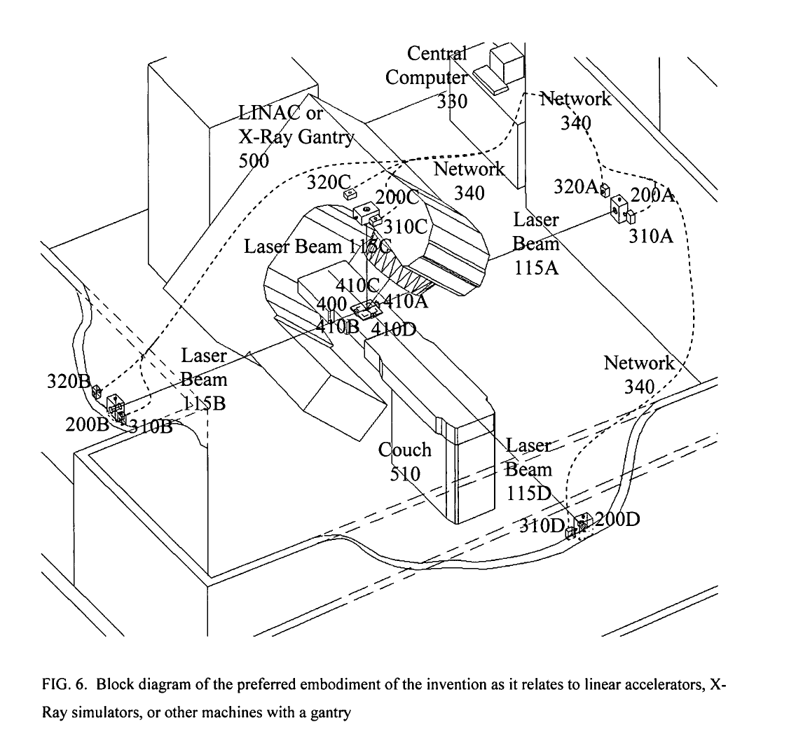

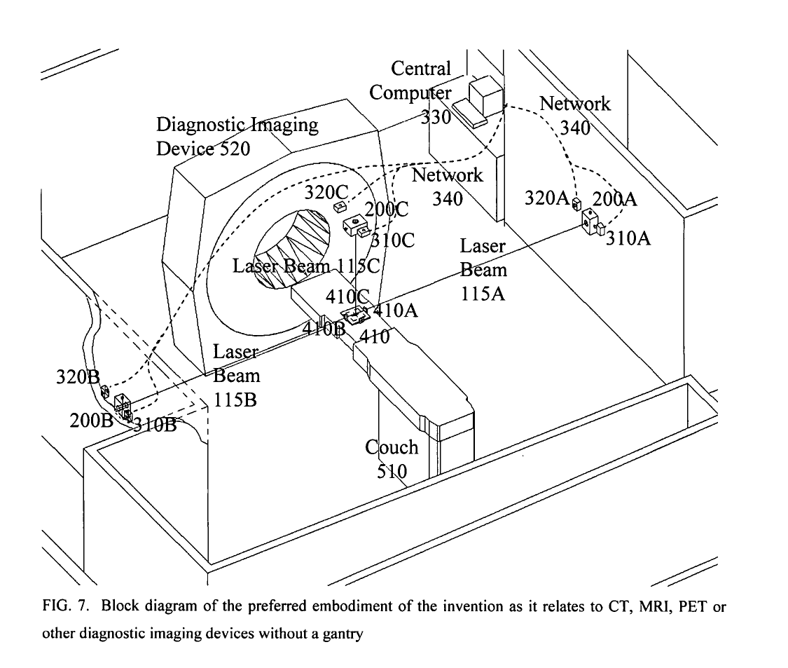

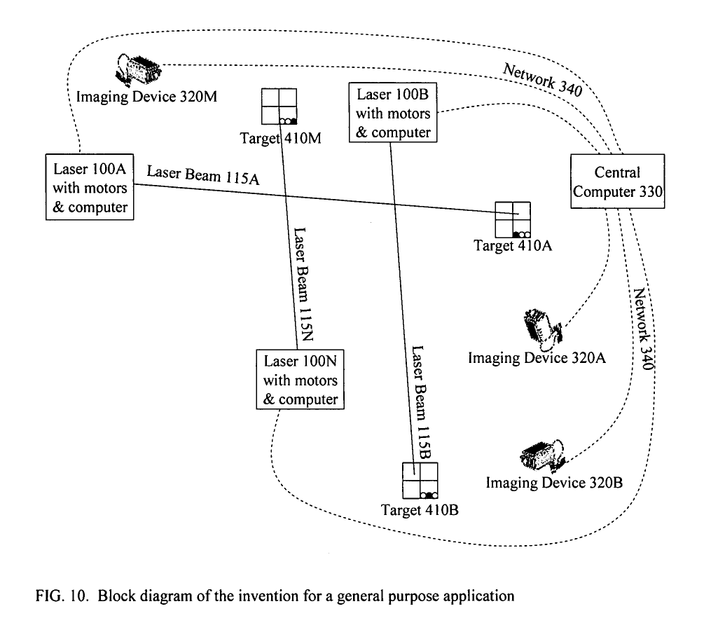

FIGS. 3-5 show several embodiments of a laser target assembly 400. These embodiments are useful for radiation oncology applications with a gantry as shown in FIG. 6 and for diagnostic imaging applications without a gantry as shown in FIG. 7. In the general case in FIG. 10, each target could be a free standing unit, or the targets could be attached to some other assembly that holds the targets in some desired orientation. Regardless of the application, each laser target 410A, 410B, 410C and 410D has crosshairs 430A, 430B, 430C, and 430D to align to, and unique identifying marks 440A, 440B, 440C, and 440D so the computer can determine which laser beam 115 to align based on which image it receives. The laser target assembly 400 in FIG. 3 also has light field alignment marks 450 that are useful in the radiation oncology applications with a gantry as in FIG. 6.

Before the alignment process is initiated, the user must position the laser alignment target 410 in such an orientation that when the laser beam 115 is aligned to it with minimal alignment error, the desired frame of reference from the laser beams is established, as depicted in the examples in FIGS. 6 and 7.

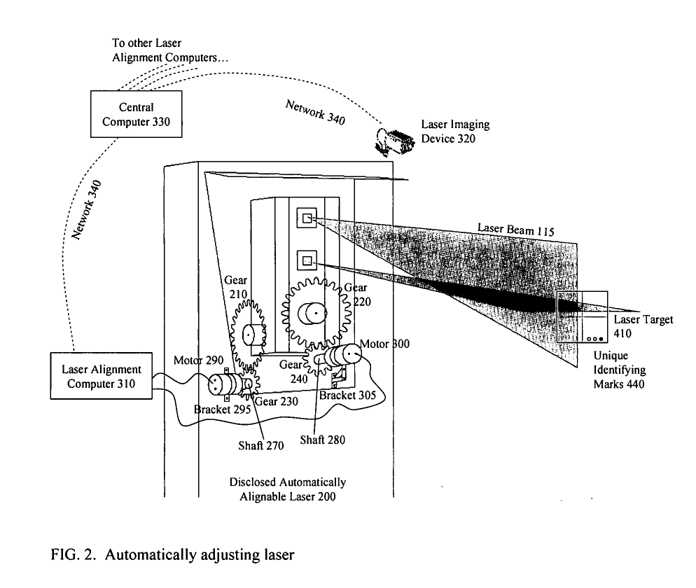

The disclosed automatically alignable laser 200 is shown in FIG. 2. The laser beam 115 is emitted from the laser 100, wherein manual adjustment means 120 is replaced by the X-Axis alignment gear, pulley, sprocket, or other connector 210 (subsequently called “gear”), and manual adjustment means 130 is replaced by the Y-Axis alignment gear, pulley, sprocket, or other connector 220 (subsequently called “gear”). Gear 210 is connected to the smaller X-Axis motor gear, pulley, sprocket, or other connector 230 via chain, belt or other connector, or in the case of two gears, gear 210 may be directly connected to gear 230. Gear 220 is connected to the smaller Y-Axis motor gear, pulley, sprocket, or other connector 240 via chain, belt or other connector, or in the case of two gears, gear 220 may be directly connected to gear 240. The X-Axis alignment motor shaft 270 extends from the X-Axis alignment motor 290, and the end of the shaft 270 is connected through the central axis of gear 230. The Y-Axis alignment motor shaft 280 extends from the X-Axis alignment motor 300, and the end of the shaft 280 is connected through the central axis of gear 240. Motor 290 is held in place by bracket 295 and motor 300 is held in place by bracket 305. When motor 290 rotates clockwise or counterclockwise, shaft 270 turns gear 230, which turns gear 210, which aligns laser beam 115 along the X coordinate. When motor 300 rotates clockwise or counterclockwise, shaft 280 turns gear 240, which turns gear 220, which aligns laser beam 115 along the Y coordinate. The laser alignment computer 310 is wired to motor 290 and motor 300, to provide power and to control which way the motors should turn. X and Y coordinates are relative to the laser assembly 200. The laser imaging device or devices 320 captures an image of the laser beam 115 impinging a laser target 410. One possible laser imaging device is a digital camera. There may be one portable laser imaging device to share among all lasers, or multiple laser imaging devices could be permanently mounted in the room and connected to the central computer 330 via the network 340. The network 340 may be wireline or wireless, or a hybrid combination wherein some segments of the network are wireline and some are wireless. It is convenient for at least the part of the network that connects to the portable computer 600 to be wireless. Typical formats of the network are Universal Serial Bus (USB) for the digital cameras, ethernet to connect to the central computer 330, and 802.11 to connect to the portable computer 600, but other formats could be used as well. The central computer 330 receives the image from the laser imaging device 320 via the wireline or wireless or hybrid network 340, or direct wired connection 340 and processes the image to calculate which way the laser beam 115 needs to be aligned to minimize the alignment error. The central computer 330 sends a signal across the network 340 to the laser alignment computer 310, to tell the computer 310 which way to adjust the laser alignment motor 290 and motor 300, to realign the laser beam 115 such that the alignment error is minimized. As the laser beam 115 is adjusted, the laser imaging device continues 320 to capture images and update the central computer 330 with new alignment information, and the central computer 330 continues to send updated control signals via network 340 to computer 310, which continues to control motors 290 and 300 to continue to minimize the alignment error of the laser beam 115. The central computer 330 could notify the user when the alignment error is sufficiently small, or for permanently mounted installations the alignment system could continue to update the alignment as long as it is powered on. The central computer 330 could be connected to other laser alignment computers 310 via the network 340. Other than these disclosed modifications, the automatically alignable laser 200 can be the same as the prior art manually adjustable laser 100.

In a configuration where the user selects which laser beam 115 to align, the central computer 330 can determine which laser to report the alignment errors for by checking the physical network 340 connection and verifying that the unique identifying marks 440 match the proper marks for that particular laser target 410. Alternatively, the responsibility for checking the unique identifying marks 440 could be left to the user instead of the computer.

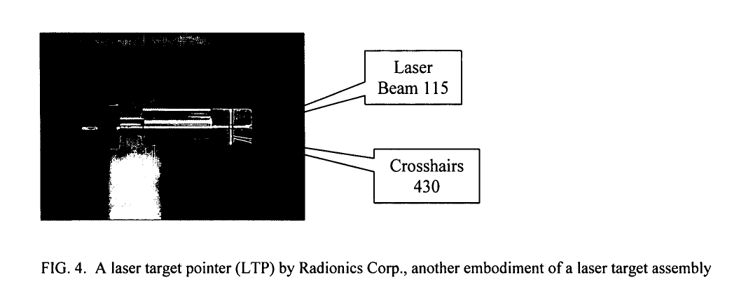

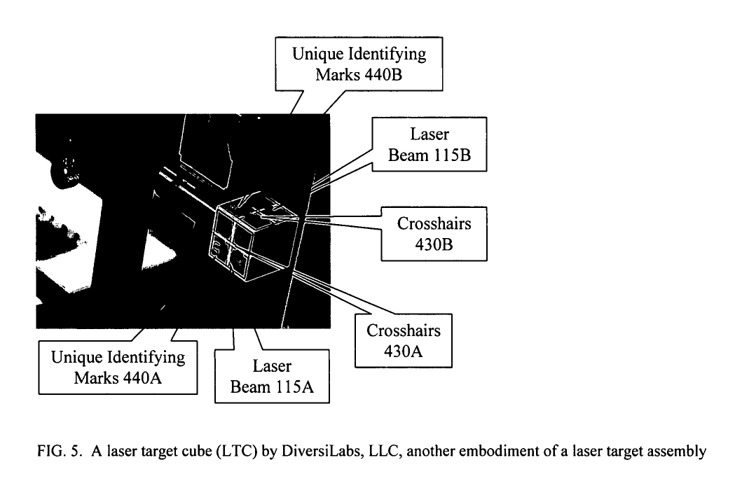

FIG. 6 illustrates the preferred embodiment of the invention for use with a linear accelerator, X-Ray simulator, or other machine that has a rotatable gantry. In order to align the laser beams 115A, 115B, 115C, and 115D to the laser targets 410A, 410B, 410C, and 410D, the user first places the laser target assembly 400 at the gantry's isocenter. For laser targets like U.S. Pat. No. 5,467,193 or FIG. 3, the vertical height of the isocenter is either determined by the gantry's optical distance indicator (ODI), or by the couch 510 height gauge, or by measuring with the linear accelerator's mechanical isocenter pointer. The lateral and longitudinal position of the isocenter is determined by aligning the gantry's light field with alignment marks on the laser target assembly 400. The ODI, couch 510 height gauge, mechanical isocenter pointer, and gantry's light field are well known in the prior art and are not described in more detail here. For laser targets as in FIG. 4 or 5, a procedure as indicated by the Winston-Lutz reference cited above is used to align the target to the linac's isocenter. For any kind of laser target, the user must then rotate the gantry 45 degrees from top-dead-center, so all laser beams 115A, 115B, 115C, and 115D have line of sight to the laser targets 410A, 410B, 410C, and 410D. After the laser target assembly 400 is positioned at the isocenter and is leveled, the laser beams 115A, 115B, 115C and 115D are aligned to the laser targets 410A, 410B, 410C, and 410D as follows. The user runs the program on the central computer 330, which initiates the laser imaging device(s) 320 to begin capturing and delivering images of the laser beams 115A, 115B, 115C, and 115D impinging on laser targets 410A, 410B, 410C, and 410D, from which the central computer 330 calculates alignment errors and sends feedback signals to laser alignment computers 310A, 310B, 310C, and 310D, which control the laser alignment assembly apparati 200A, 200B, 200C, and 200D as heretofore described, to minimize the alignment error.

For applications with a gantry as in FIG. 6, the gantry must be rotated out of the way before the ceiling laser beam 115C can be aligned to the corresponding target 410C. For most gantries, if the gantry is rotated 45 degrees from top dead center, all the laser beams 115A, 115B, 115C, and 115D can strike their respective targets 410A, 410B, 410C, and 410D at the same time.

There may be one or many laser imaging devices 320. If there is a single laser imaging device 320, the user must point it at one laser alignment target 410 and initiate the program on the central computer 330, and sequentially do this to all other laser alignment targets. If there is more than one laser imaging device 320, several of the laser beams 115A, 115B, 115C, and 115D may be aligned simultaneously, as fast as the central computer 330 is able to sequentially receive and process images from the laser imaging devices 320 and send feed back to the laser alignment computers 310.

FIG. 7 illustrates the preferred embodiment of the invention for use with CT, MRI, PET or other diagnostic imaging devices without a gantry. The setup is identical to that of FIG. 6, except that 1) typically there is no foot laser 115D because there is no gantry to ever block the ceiling laser 115C, and 2) there is no light field or ODI or mechanical isocenter pointer to assist placing the laser target assembly 400 at the model isocenter. In this case the couch 510 height gauge could be used to adjust the laser target assembly 400 to the vertical height of the model isocenter. The lateral and longitudinal position of the laser target assembly 400 could be set to a certain location on the couch 510 when it is in a reference position, designating the lateral and longitudinal position of the model isocenter. Once the laser target assembly 400 is positioned at the model isocenter, the laser alignment process is the same as described for FIG. 6.

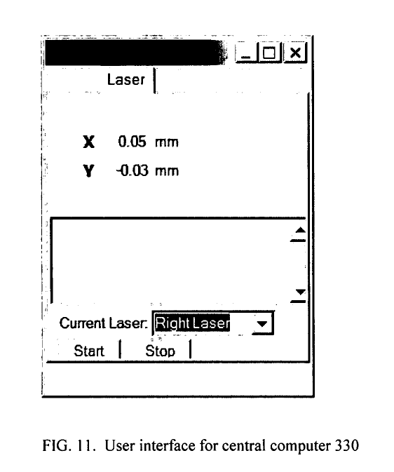

In the simplest embodiments of the invention, the laser imaging device is a digital camera, which is configured to store an image in a particular directory on the central computer 330 each time the user depresses the shutter on the camera. In this simple embodiment, the program just loads and processes the newest image in that directory each time the user clicks Start in the user interface on the central computer, as shown in FIG. 11. In more elaborate embodiments, the program can control when the camera captures the images, and the images can be transferred directly into the program's memory without first being saved to disk.

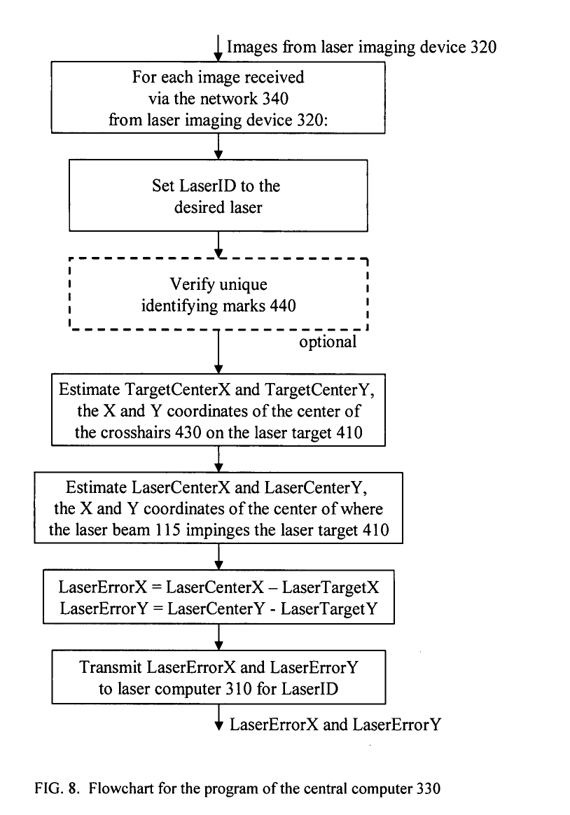

FIG. 8 shows a flowchart for the program of the central computer 330. The central computer 330 receives images from the laser imaging device(s) 320 via network 340. For each image, the LaserID variable must be set to the currently selected laser, either manually by the user as in FIG. 11, or the central computer 330 can analyze the unique identifying mark 440, or the physical network 340 connection from which the image was sent could be checked. Then the central computer 330 estimates the X and Y coordinates of the center of the crosshairs 430 on laser target 410, and the X and Y coordinates of the center of where laser beam 115 impinges laser target 410, and subtracts to get the error feedback signals LaserErrorX and LaserErrorY. Line estimation techniques are well-known in the literature as in the works cited by Maybank, pp. 1579-1589, Bonci et al., pp. 945-955, Merlet et al., pp. 426-431, and Basseville et al., pp. 24-31, and many others. Then the central computer 330 transmits LaserErrorX and LaserErrorY to the corresponding laser alignment computer 310 via network 340. FIG. 8 shows an embodiment in which the program runs continually. In an alternative embodiment, the central computer could wait in an idle loop until the user initiates the program, and the program could halt when the alignment error is sufficiently small. Another embodiment would be to have the program continue to run until the user decided the alignment error was sufficiently small, and allow the user to halt the program.

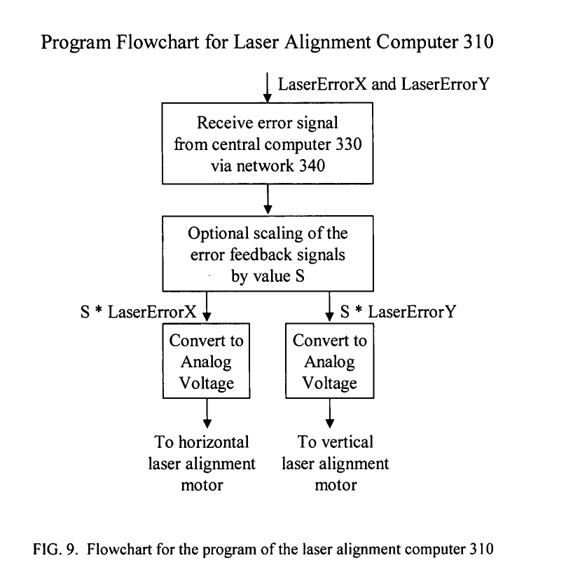

FIG. 9 is a flowchart for the program of the laser alignment computer 310. Whenever a particular laser alignment computer 310 receives the error feedback signals LaserErrorX and LaserErrorY from central computer 330 via network 340, it may scale the error feedback signal by a scale factor to improve performance, as per feedback control systems theory. Then the scaled value is converted to an analog voltage, and the X coordinate value is fed to the X coordinate alignment motor 290 and the Y coordinate value is fed to the Y coordinate alignment motor 300.

FIG. 10 illustrates a general purpose embodiment of the invention that is not limited to use in radiation oncology or diagnostic imaging. In the general embodiment each laser 100A through 100N is aligned to the corresponding target 410A through 410M, where N and M are arbitrary positive integers. The laser targets 410A through 410M could be attached to a laser target assembly 400 or each laser target 410A through 410M could be separate.

In the general case, the invention is capable of aligning any laser to any target, as directed by the user, or as is determined from the configuration of the targets. For example, if laser target assembly 400 in FIG. 6 was flipped upside down, laser beam 115A would need to align to target 410B, and laser beam 115B would need to align to target 410A.

If a laser is initially so far out of alignment that it doesn't even impinge on the target, the user can move the target to a location where the laser still can impinge it, and use the invention to align the laser to that point which is closer to the desired point but still misaligned. Then the user can move the target to the desired location or closer to it, and repeat the process until the proper alignment is achieved.

In another embodiment, the central computer 330 also serves as the laser alignment computers 310A, 310B, 310C, and 310D. This can be accomplished if the central computer 330 has an output connection for each of the lasers' motors.

While the invention has been described in connection with what is presently considered to be the most practical and preferred embodiment, it is to be understood that the invention is not to be Limited to the disclosed embodiment, but on the contrary, is intended to cover various modifications and equivalent arrangements included within the spirit and scope of the appended claims.

References Cited

| | | |
|---|---|---|
| 5142559 | August, 1992 | Wielopolski |
| 5467193 | November, 1995 | Laewen |
| 5823192 | October, 1998 | Kalend |

Winston, K. R, Lutz, W., “Linear accelerator as a neurosurgical tool for stereotactic radiosurgery,” Neurosurgery, 1988, March; 22(3):454-464.
Maybank, S. J., “Detection of image structures using the Fisher information and the Rao metric,” IEEE Trans. on Pattern Analysis and Machine Intelligence, Vol. 26, Issue 12, pp. 1579-1589, December 2004.
Bonci, A.; Leo, T.; Longhi, S., “A Bayesian approach to the Hough transform for line detection,” IEEE Trans. on Systems, Man and Cybernetics, Part A, Vol. 35, Issue 6, pp. 945-955, November 2005.
Merlet, N.; Zerubia, J., “New prospects in line detection by dynamic programming,” IEEE Trans. on Pattern Analysis and Machine Intelligence, Vol. 18, Issue 4, pp. 426-431, April 1996.
Basseville, M.; Espiau, B.; Gasnier, J., “Edge detection using sequential methods for change in level—Part I: A sequential edge detection algorithm,” IEEE Trans. on Acoustics, Speech, and Signal Processing, Vol. 29, Issue 1, pp. 24-31, February 1981.

We claim:

1. A computer assisted laser alignment device that measures the alignment error of laser beams to corresponding targets and displays the alignment error to the user, said device comprising
(a) one or more lasers, with a laser beam emanating from each said laser,
(b) a corresponding laser target for each said laser,
(c) crosshairs or other alignment information on each said laser target,
(d) means for automatically aligning the beam from each said laser positive or negative in the X direction, and positive or negative in the Y direction,
(e) a laser imaging system to capture images of said laser beam impinging each said target,
(f) a central computer that processes all said images from said laser imaging system, to measure how accurately each said laser beam is aligned, and that controls said means for automatically aligning each said laser.
